(19) United States
(12) Patent Application Publication
(10) Pub. No.: US 2002/0172797 A1
(43) Pub. Date: Nov. 21, 2002

(54) Table cover providing functional napkins

(76) Inventor: Yukihiro Sugawara, Tokyo (JP)

Correspondence Address: Jay L. Chaskin, 80 Washington Street, Norwalk, CT, 06854, US

(21) Appl. No.: 10/147,217

(22) Filed: May 14, 2002

(30) Foreign Application Priority Data
May 15, 2001 (JP) 2001-182577

(51) Int. Cl. B32B 3/06

(52) U.S. Cl. 428/99; 428/100

(57) ABSTRACT

A table cover in the present invention comprises a rectangular sheet material such as a cloth, a synthetic resine material, etc., and multipe napkin pieces which is same material and is formed in a body with the former respectively.

The napkin pieces project beyond side egdes of the sheet material and are cut off on their both side portions by a fixed length from the later.

The napkin pieces also are attached optional sets of fastening members or buttons on their projected edges and on their opsite porions inward the side edges of the sheet material.

Thus, those napkins can maintain cleanly on the table surface by scraping up spilled foods or spilled liquids thereon into their held portions on one's laps and prevent dirts of the dress or carpet, during a meal.

The napkin pieces can also be held back to fix them within the sheet side portions, upon it's inactivity, as seen apparently as a usual table cover on a dining table.

### CROSS-REFERENCE TO RELATED APPLICATIONS

This application claims priority under 35 U,S.C. §119 to Japanese Patent Application No. 2001-182577 filed May 15, 2001, the entire contents of which is hereby incorprated by reference.

### BACKGROUND OF THE INVENTION

This invention relates to a table cover providing functional napkins and more particularly the functional napkins which can prevent to contaminate a dress and can hold on them foods droped out the table, during a meal.

Customary, it has been in fashion to use the table cover including a table cloth selected by an one's choice or one's sense, for prevention of dirts on the table surface and for representation of a pleasant spot during the meal.

While, those table covers have been provided in various types so that the market enables to supply not only various materials to correspond with any one's likings, for example a cloth, a synthetic resine sheet, a water proof table cover adhered a cloth and a transparent sheet to give a cloth taste, but also various designs, patterns, or appearances thereof.

Those table covers have generally been used for prevention of the dirts on a surface of the table and for enhancement of an atomosephere in a dinning room.

In the other way, an infant or an old man sometimes spills on the table foods or contaminates his dress or a carpet, due to the former can not take well the meal, and the later is invonvenient of his body also. Accordingly, the former wears a bib and the later puts a napkin or a towel on his lap for their meal respectively for the above purposes, and under certain circumstances, the later uses an apron provided a private pocket for the spilled foods.

In view of such spilled foods, during the meal, Japanese Utility Model Registraton Nos. 3019803 and 3067791 teaches respectively a table cover which privents the dirts on the dress even if the foods spilled on, during the meal.

Firstly, The Utility Model Registration No. 3019803 teachs a table cover providing four pieces of the cloth attached on it's four sides by tape fasteners to form four bend portions so that crumbs or spilled liquids, during the meal, can be received in those portions and maintained cleanly on the table surface.

Secondly, Utility Modele Registration No. 3067791 discloses also a table cover which can be used both as a bib and a table cloth by attaching a string on one side of a rectangular vinyl cloth, just same size as the table surface.

In it's application, the table cover is firstly spreaded on the table to put on it the tableware, after it's string is tied about a neck of the infant or the old man, and thereafter they can take the meal, without any dirts of their dresses or on the carpet.

The table surface can be also maintained cleanly to use again, without any sweeping, by merely washing the removed table cover.

The both prior arts clearly teachs respectively the table covers, objected to the infant or the old deformed person, which can prevent the dirts on the table surface and the dresses, during the meal.

As mentioned above, various products and arts, such as the convinient napkin and the bib which can receive the spilled food during the meal, as well as above table covers, have been provided for the dinning ware market for the production of pleasant meal, preventon of the dirts and reduction of a charge for an atendant of the infant or the old deformed person, and those products to be indispensable fixtures for the dinning table, in future. Especially, a household which uses the napkin, as a table manner, is recently increasing gradually even if there is no infant or deformed old person.

Meanwhile, all persons including an adult, the infant and the deformed old person have to take respectively the meal every day and, in each meal of the infant and the deformed old person, his mother or family had to surely help their meal so that they can take well it without spilling out the tableware and don't contaminate the dress, carpet or floor by the spilled foods.

Those indispensable assist every day is a heavy working for the related persons, not to say nothing of themself.

Those table covers described hereinbefore for the prevention of the dirts of the dress and the table surface in the meal of such infant and deformed old person, could attain some effects in it's own way for their purposes, however, they have still follwing inconviniences and foults.

Firstly, an exclusive apron or bib providing a large pockt and objecting to the infant or the deformed old person could attain a certain effects for prevention of the dirt on the dress or the carpet, however, the spilled food thereon could not be almost received into the pocket because the infant does not take quietly the meal, and the vital pocket has been smashed because it is attached at his front portion and moreover he takes the meal at a pose such as overlaped on the table.

Accordingly, such apron or bib for the meal did not be efectively to him. Contrarily, the deformed old person takes the meal calmy, however, most of them disliked to use such private apron or bib because it is unattractive and gives him a sense of incongruity in his family to use it.

Additionally, the table cover disclosed in Utility Model Registration NO. 3019803 comprises a table cloth covered on a table surface and same table cloth pieces formed respectively on four sides of the former hem for receiving crumbs and spilled liquid also, however, they can merely receive the spilled crumbs and liquids on the table surface and those crumbs and liquids had to scrape down into the hems after the later closed by tape fasteners were somewhat released every time.

Accordingly, the table cloth is inconveniently to use and has an another shortages because the preventions of the dirts of the dress or carpet is impossible at all, due to those hem portions being attached shortly arround the dinning table.

An after disposal of the table cloth is troublesome very much also.

The table cover in Utitility Model Registration No. 3067791, discloses a rectangular table cloth of which is used both as a bib and table cloth attached a string on an one side of a vinyl cloth covered on a table surface.

The cover does not to say that it is a novel table cover because it is merely a large size bib and further has not a constant space or surplus also between the vinylcloth for prevention of the dirt and a root portion of the infant's neck, when it is used for the meal, due to it is directly tied around the neck. Therefore, the table cover can neither affect technically nor actually to an anticipation of an user for the tablewares thereon are removed and over-turned, according to a replacement of the table cover linked with a movement of the infant.

### SUMMERY OF THE INVENTION

In order to over-come above faults and inconveniences, the present invention provides with a table cover having functional napkins which can enhance an atmosphere during the meal, maintain clean on a table surface, privent dirts of the dress, and receive spilled food on the table into turned-over portions of the napkins.

The table cover comprises a rectangular sheet of a larger cloth or synthetic resine material than the table surfaces, and provides napkin pieces attached on longitudinal both sides of the rectangular sheet and projected in a fixed length and width from the table cover brims.

The napkin pieces is cut off at it's both sides respectively until near portions of the table surface brims and plural sets of fastening means such as male-female planar fasteners or hooks are furnished on those edges of the cut napkins and on near portions of the table brims opposed to the edges of the cut napkins when they were held back.

Those napkins therefore may be held back around the all side portions of the rectangular sheet on the table surface when the meal does not be taken, and contrarily, during the meal, they can freely use after released from the later portions.

Those functional napkins also provide a string or a hunging loop respectively on their edge portions to maintain them exactly on an one's lap to prevent dirts of the dress or carpet, etc., as described hereinafter in detail.

Accordingly, it is an object of the present invention to provide with a table cover having functional napkins projected through brims of the former and cut their both sides by an appointed depth on the former to prevent dirts of the dress or carpet and to clean on the table surface by scraping off spilled foods or liquids thereon into the functional napkins turned up on the one's lap, and further provided plural sets of male-female hastening members at their brim portions and oppsite portions for their holding backs on all sides of the former, respectively.

An other object of the present invention is to provide for a table cover having the above functional napkins and the later providing plural sets of male-female plarnar fasteners or hooks at their same portions for the fastening members, for the same sakes as the above.

Still an other object of the present invention is to provide for a table cover having the above functional napkins attached on their brims respectively a string of an appointed length to cover exactly one's front portion by hanging it around one's neck for the same sakes as the above.

Further object of the present invention is to provide for a table cover having the above functional napkins which were made separately and attached detachablely on the former by plural sets of male-female fastening member on an end of the back surface of the later and on opposite portions on the surface of the former, for the holding backs of the laters, at all sides of the former.

Still an another object of the present invention is to provide for a table cover having above functional napkins which were made separately and attached detachablely on the former by plural sets of male-female fastening members set on an end of the back surface of the later and on more inward portions than opposite portions on the surface of the former, for the holding back of the laters at all sides of the formers.

Still further more object of the present invention is to provide for a table cover having above fuctional napkins provided slip-proof members on their backs to fix them on each one's lap, during a meal.

Other objects and advantages of the present invention will become apparent from a study of the follwing portions of the specification, claims and the attached drawings.

### BRIEF DESCRIPTION OF THE DRAWINGS

FIG. 1 is a development view of a table cover for an embodiment of the present invention.

FIG. 2 is a perspective view of the table cover of FIG. 1 covered on a table.

FIG. 3 is a side view showing an usage of the table cover of FIG. 1, during a meal.

FIG. 4 is a development view of a table cover for an other embodiment of the present invention.

FIG. 5 is a perspective view of the table cover of FIG. 1, covered on a table, during a meal.

FIG. 6 is a development view of a table cover for an other embodiment of the present invention.

FIG. 7 is a development view of a table cover for a still another embodiment of the present invention.

FIG. 8 is a side view of a functional napkin of the present invention providing a string on it's edge for hanging around an one's neck.

FIG. 9 is a side view showing a table cover provided the functional napkins in FIG. 8, during a meal.

FIG. 10 is a perspective view showing functional napkins of the present invention provided a slide-proof member respectively on their backs and held back on a side portion of a present table cover developed on a table.

### DETAILED DESCRIPTION OF THE INVENTION

### EXAMPLE 1

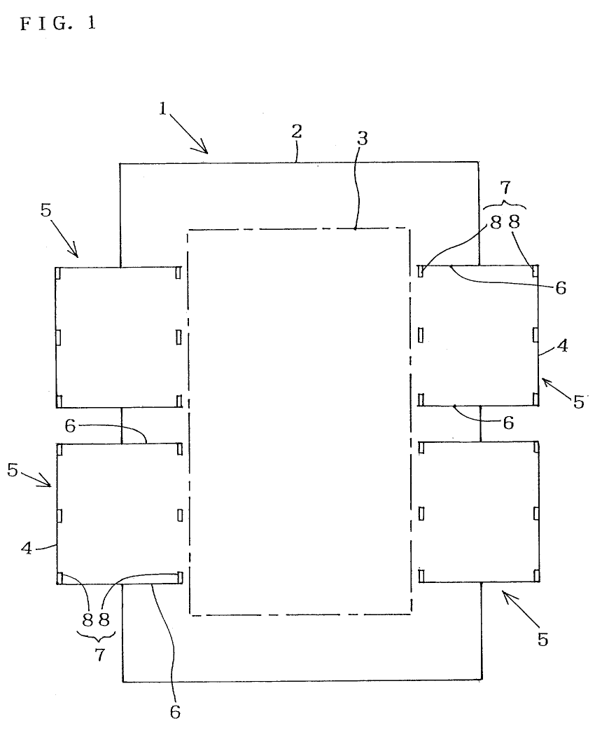

An embodiment of the present invention shown in FIGS. 1 to 3, is a table cover (1) which comprises a rectangular sheet (2) of a cloth or a synthetic resine material as a base and two napkin pieces (5) (5) shown as projected pieces (4) (4), which are in a body with the sheet at it's both longitudinal side portions, and have a length, from their edges to near portions of the table edge placed inwardly on the sheet (2), and a width which can cover suficiently over the one's lap respectively.

The functional napkins (5) (5) separated laterally each other in a fixed distance are also cut off at their both sides with two slits (6) (6), until the edges of the sheet (2) from the near portions of the table edges covered by the longitudinal side portions of the sheet (2), and plural sets of fastening members (7) (7) such as male-female plarnar fasteners are prepared at the edge portions of the napkins (5) (5) and the near portions of the edges of the table (3) to fix them by holding back on the both longitudinal side portions of the table sheet (1), when the napkins are inactivity.

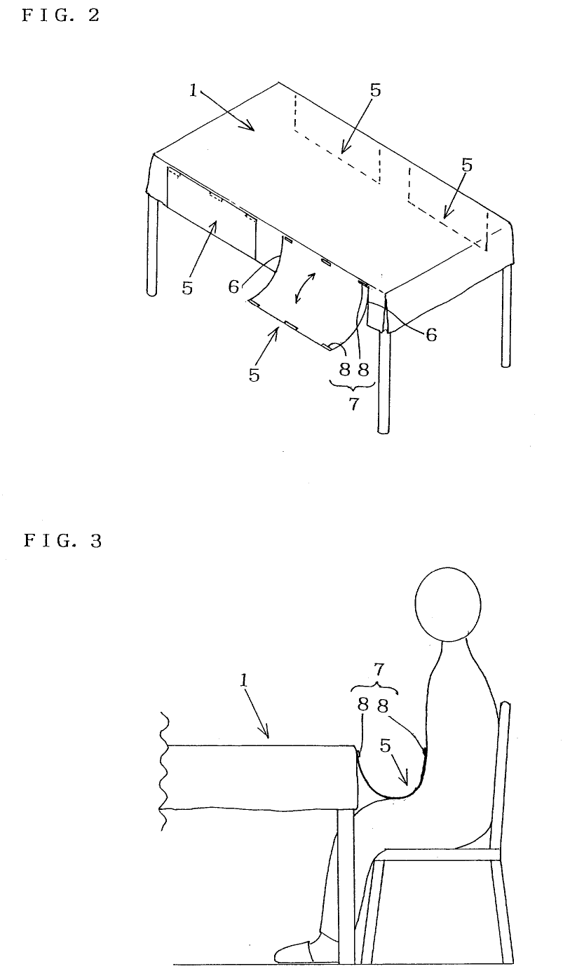

Accordingly, the table cover (1) may be used as a table cloth to cover the table together with napkins of which prevent dirts of a dress or carpet by covering merely the lap of the user and also seen apparently as a common table cover, upon it's inactivity, because the napkins can be easily fixed within it's side prtions by holding back them, with several sets of the planar fasteners (8) (8) thereon, after cleaned their dirt portions only, as shown in FIG. 2.

### EXAMPLE 2

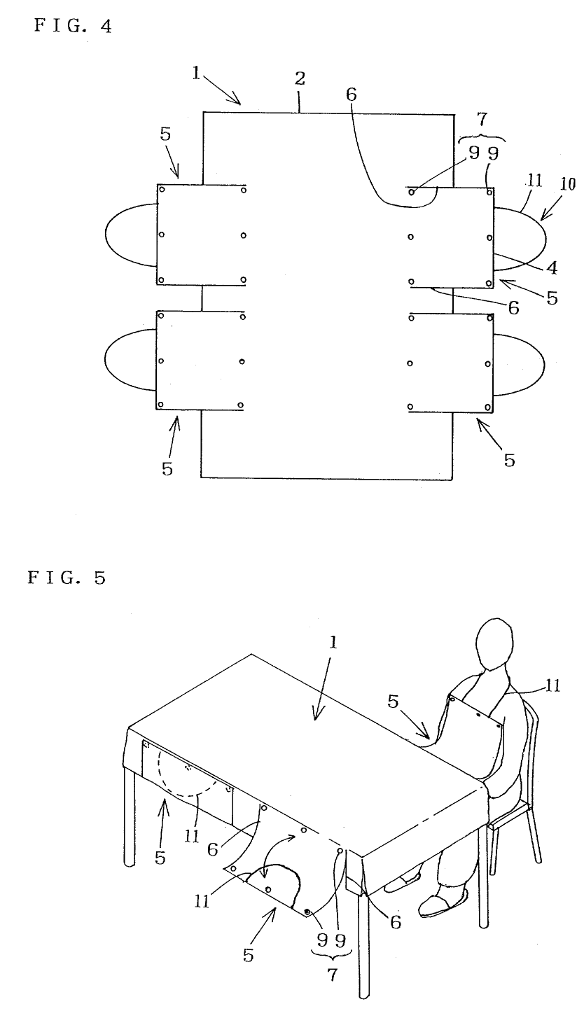

A table cover shown in FIGS. 4 and 5, is an other embodiment of the invention and comprises almost same form and same compornents as the embodiment in Example 1, except for hanging ropes (11), attached on each edges of the napkins (5) (5) having a length which enables to hang suficiently around one's neck and for several sets of hooks (7) (7), equiped on the same portions for the planar fasteners (7) (7) shown in FIGS. 1 and 2.

The napkins (5) is respectively fixed on each side portion of the table cover (1) by those sets of hooks (7) (7) after their holding back with the hanging ropes (11), as shown in FIG. 5.

In usage, it is released from the side portion of the table cover firstly by discharging a connection of the hooks (7) (7) and the hanging rope (11) is held around the neck, after pulling out it from inside of the held back napkin (5).

Such napkin piece (5) is so held around the neck by the rope (11) with enough room that a little or more movement of an infant, during the meal, is absorbed perfectly therebetween without any delivery of the movement to the napkin piece (3) or the table cover (1), due to free movement of the napkin and the hanging lope (11) around the neck.

Accordingly, there is no slightest fear of over-turn of the article on the table by such movement of the infant, during the meal.

### EXAMPLE 3

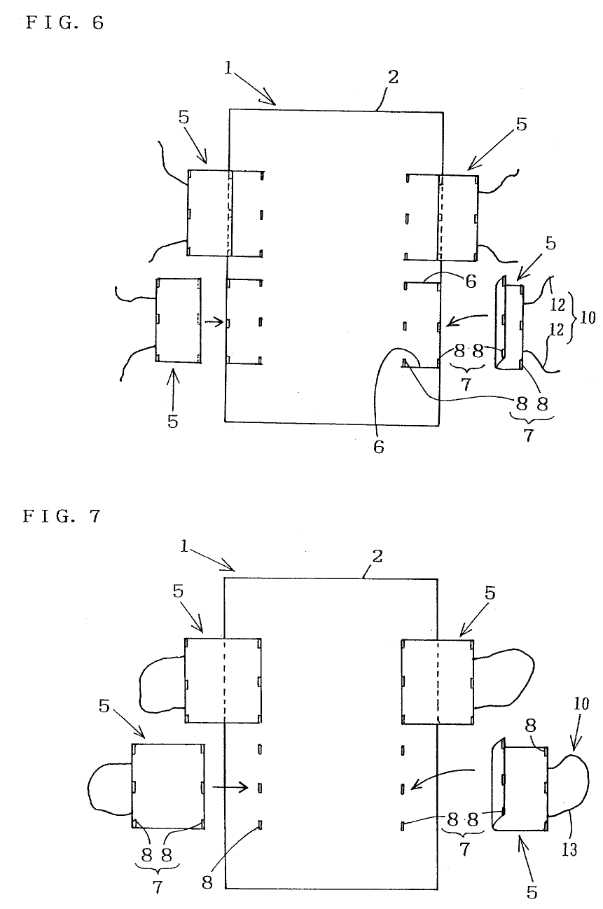

A table cover shown in FIG. 6, is an another embodiment, and comprises a rectangular sheet (2) and detachable napkin pieces (5) (5) in the former.

Two longitudinal side portions of the sheet (2) forming a main body of the table cover (1), provide two sets of slit (6) (6) having a same length and same width as those described in the above each embodiment, and half sets of fastening members (7) (7) such as male-female planar fasteners (8) (8), are attached on one edge of the sheet material between those slits (6) (6), for connecting means of the napkin pieces made of the same material and separately made from the sheet (2), respectively/

While, other half sets of the plarnar fasteners (8) (8) are also attached on one endge of a back surface of the napkins (5) (5) of which was made separately in a same width as a distance between the two slits (6) (6) and a half length of the slits respectively.

Furthermore, another fastener means (7) (7) for holding back of the napkins (5) (5), such as some sets of male-female planar fastener (8) (8) are prepared at opposite portions to holding the turned napkins (5) (5) on the both longitudinal sides of the table cover, and string members (10) (10), such as sets of strings having a desirable length to tie them around the neck, are attached also on opposite sides of the planar fasteners (8) (8) prepared on the back surfaces of the napkins.

Thus, those napkins (5) (5) provide for an another functional table cover (1) of the present invention, with the rectangular table sheet (2) discribed hereinbefore.

Accordingly, the embodiment in Example 3 provides not only a same function and a same handling but also a same effct as the embodiments in Examples 1 and 2, and provides a further effect such that the suitable length of the strings to be tied around the neck, upon the meaing, can be easily adjusted also to a short torsoed child, etc., due to a tieing system of the two strings.

Further, the soiled napkin pieces (5) (5) can be washed separately after took off the table cover (1) also.

### EXAMPLE 4

A table cover (1) of this embodiment is a same type of Example 3 that the functional napkin pieces (5) (5) is respectively detachable from the both sides of the table cover (1), except for having no slits for the napkins on the both sides of the table cover and being in double length and same width of the napkins in Example 3.

The rectangular table sheet (2) constitutes a main body of the table cover (1), and provides half sets of planar fastener pieces (8) (8) at near portions of the edges for the table surface hereunder and at one of edges for it's longitudinal side portions, respectively.

The napkin pieces (5) (5) is also prepared separately from the sheet (2) and half sets of the planar fasteners oposited to above other half sets of planar fasteners are attached on the backs of edges of the napkin pieces (5) (5) so that the napkin pieces can be attached detachabely on the side portions of the table cover (1).

The fasteners is further attached on both edges of their surfaces respectively some sets of male-female planar fastener (8) (8) to hold back them on the both sides of the sheet, upon their inactivity.

While, the napkins provide also an elastic hanger (10) such as a rubber band (13) at one edge of the napkins respectively, as shown in FIG. 7.

The embodiment in Example 4 is a same type foundamentally as Example 3, except for the former lacking two sets of slits for the napkins (5) (5) and some sets of fastener members such as the planar fasteners (8) (8) at edges of the both sides of the table cover (1), and the napkins having a double length of the embodiment in Example 3, respectively.

Accordingly, the table cover (1) in Example 4 is more simpler than it in Example 3 and it's napkins (5) (5) made separately from the table cover (1) have same effects as the embodiment of Example 3, even if they have no slits with the both sides of the table cover (1), due to they have not only a double length of them in Example 3 and an elastic hanger (13) at their one edges but also some sets of oposite planar fasteners (8) (8) to the planar fasteners attached at near portions of the edge portions of the table surface on the both sides of the table cover (1), as shown in FIG. 8.

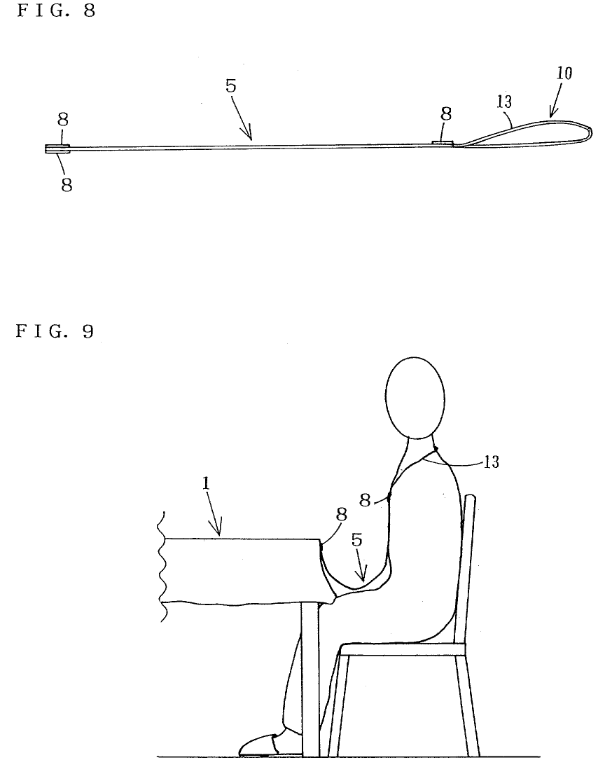

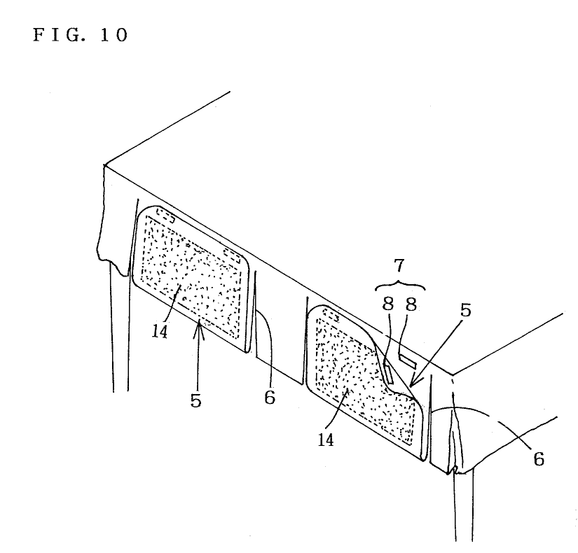

Consequently, the table cover (1) can minimize influences of the veriouse movements transfered through the napkins (5) because the elastic hanger (13) attached on the later can freely extend to correspond to differences of the setting height and to suficiently absorve the above movements thereon, due to the longer napkins and elongation of the hanger, as shown in FIG. 9.

### EXAMPLE 5

An another table cover (1) of the present invention is shown in FIG. 10 and it is an almost same type as shown in the examples described thereinbefore, except for functional napkins (5) (5) provided slide-proof members (14) (14) on their back surfaces.

The napkins (5) (5) can prevent to slip down or move about themselves on the laps, upon their activity, due to increased resistances between the both.

The napkins (5) (5) are able to hold back on all side portions of the table cover (1) as same as the other embodiments also, as shown in FIG. 10.

In those embodiments, each set of the fastening members (7) (7) on the nakins (5) (5) and the table sheet (2) may be a button or a set of hook and the like, and a multiple short planar fastener series shown in the each drawing may be replaced by a long planar fastener.

The napkins (5) (5) may be prepared not only on the both side longitudinal sides but also on all sides of the table cover (1).

The colors or patterns of t he napkins are of-course free choice, accoding to one's own taste for their pleasant, during the meal.

Various modificaton or subsitution of equivalent compornents, colors, patterns, forms, and/or fuctions may be made by those skiled in the art to the desclosed embodiments without departing from the scorpe and extend of the invention.

What ia claimed is:

1. A table cover provided fuctional napkins for covering a dining table, conprising a rectangular sheet material and projected napkin pieces hereon having a fixed width and length, and formed as one sheet with the former, optional numbers of the later being prepared on optional sides of the table cover and one or more sets of male-female fastening members being attached on each edge portions of the laters and on their opsite portions located inside of the later, separately.

2. A table cover provided fuctional napkins for covering a dining table in claim 1 wherein the fastening members prepared on the rectangular sheet material of the table cover and the napkin pieces being respectively optional sets of male-female planar fasteners.

3. A table cover provided fuctional napkin pieces for covering a dining table in claim 1 or 2 wherein both sides of the napkin pieces on the rectangular sheet material of the table cover, being cut off by a fixed length from edges of the sheet material.

4. A table cover provided fuctional napkin pieces for covering a dining table in either claims 1 to 3 wherein string members having a fixed length being attched on edges of the napkin pieces of the rectangular sheet material of the table cover.

5. A table cover provided functiona napkin pieces for covering a dining table in either claims 1 to 4 wherein the napkin pieces attached on the rectangular sheet material of the table cover being made separately from the sheet, the napkin pieces providing optional sets of male-female fastening member on both edges of their surfaces, and optional each halves of the other fastening members being attached on back edges of the napkin pieces and edges of the rectangular sheet material respectively so that the former is detachable from the later.

6. A table cover provided fuctional napkin pieces for covering a dining table in either claims 1, 2 and 4 wherein the napkin pieces attached in the rectangular sheet material of the table cover being made respectively from the sheet material, the napkin pieces providing optional sets of male-female fastening member on both edges of their surfaces, and optional each halves of the other fastening members being attached on back edges of the napkin pieces and on near inward portions of the sheet material surface oposited to the former, so that the former being easily detachable from the later.

7. A table cover provided functional napkin pieces for covering a dining table in either claims 1 to 6 wherein the napkin pieces attached on the rectangular sheet material of the table cover, providing a slid-proof member on their back surfaces due to preventing their all planar movements on one's laps, during their activities.
